(19) United States
(12) Patent Application Publication
(10) Pub. No.: US 2011/0181941 A1
(43) Pub. Date: Jul. 28, 2011

(54) RAPID PROTOTYPING APPARATUS AND METHOD OF RAPID PROTOTYPING

(75) Inventor: Henning HENNINGSEN, Lasby (DK)

(73) Assignee: Huntsman Advanced Materials (Switzwerland) GmbH, The Woodlands, TX (US)

(21) Appl. No.: 13/082,551

(22) Filed: Apr. 8, 2011

Related U.S. Application Data
(62) Division of application No. 11/915,000, filed on Nov. 20, 2007.

(30) Foreign Application Priority Data
May 20, 2005 (DK) PA 2005 00741

(51) Int. Cl. G02B 26/00

(52) U.S. Cl. 359/290

(57) ABSTRACT

The invention relates to a method of illuminating at least one rapid prototyping medium (RPM) wherein the illuminating is performed by at least two simultaneous individually modulated light beams (IMLB) projected onto the rapid prototyping medium (RPM) and wherein the rapid prototyping medium is illuminated with light beams (IMLB) having at least two different wavelength contents (WLC1, WLC2)

### CROSS REFERENCE TO RELATED APPLICATIONS

This application is a divisional of U.S. patent application Ser. No. 11/915,000, pending, which is the National Phase of International Application PCT/DK2006/000276, filed May 19, 2006 which designated the U.S. and which claims priority to Pat. App. No. 2005 00741 (DK) filed May 20, 2005. The noted applications are incorporated herein by reference.

### FIELD OF THE INVENTION

The invention relates to a rapid prototyping apparatus and a method of prototyping and a light sensitive medium for such method and such apparatus.

### BACKGROUND OF THE INVENTION

In connection with the manufacturing of mechanical prototypes, and especially during the production design processes, recent years have introduced various types of rapid prototyping techniques (RP) where three dimensional objects are manufactured by sequential cross section layers generated by a given illumination, sintering, setting or placing of material etc. on each cross section. The individual cross sections are e.g. generated as computer-aided designs. The advantage of RP is that the manufacturing of expensive molding tools for the design of the apparatus becomes superfluous for its manufacturing, just as difficult and time-consuming modifications of a molding tool may almost be completely avoided.

Also, various techniques have been made available for the manufacturing of relatively inexpensive and fast prototype or 0 series molding tools based on a manufactured Rapid Prototype.

One type of RP technique is used in e.g. stereolithographic apparatuses, also called SLAs. This technique is based on the individual layers or cross sections of a prototype being manufactured by a photo-sensitive medium and hardened into one monolithic prototype by means of computer-aided illumination.

U.S. Pat. No. 6,658,314 discloses an apparatus of the above type where e.g. the modulus of elasticity of the hardened 3D material may be selectively controlled on the basis of adjustment of radiation wavelength. A problem related to this technique is that the controlling of e.g. the modulus of elasticity or hardness may be quite complicated and the obtained properties may vary from layer to layer of the resulting object.

### SUMMARY OF THE INVENTION

The invention relates to a method of illuminating at least one rapid prototyping medium (RPM) wherein said illuminating is performed by at least two simultaneous individually modulated light beams (IMLB) projected onto said rapid prototyping medium (RPM) and wherein said rapid prototyping medium is illuminated with light beams (IMLB) having at least two different wavelength contents (WLC1, WLC2)

According to the invention several significant advantages has been obtained. One of these advantages relies in the fact that it has been realized that fluctuation of resulting curing may be minimized or controlled when applying multi-beam illumination. This advantage may in some applications be obtained due to the fact that the scanning time related to each layer may be kept within a reasonable time tolerance. A further advantage, which may be obtained according to the invention, is that the difference in physical, optical, electrical, chemical, magnetic or any other relevant properties including any combinations hereof between the different layers of the resulting object may be kept low simply due to the fact that the illumination steps where the individual layer is illuminated with different wavelength content may be completed in a very short time or even coincident in time.

Rapid prototyping generally refers to rapid manufacturing techniques such as rapid tooling, rapid manufacturing and of course the conventional understanding of rapid prototyping.

The term simultaneous designates that the individually modulated light beams are concurrent at present at least partly at the same time if the relevant pixel is “on”.

It is noted that the invention facilitates use of more than two different wavelength contents and thereby offers the ability to obtain three or more different properties obtained through the different wavelength content.

In certain context such exposure would become extremely complicated if not impossible due to the fact that the problem related to predictability with respect to achieved properties increases with numbers of illumination steps according to the prior art.

In an embodiment of the invention said illuminating is performed by at least five, preferably at least ten or more preferably at least twenty simultaneous individually modulated light beams (IMLB) projected onto said rapid prototyping medium (RPM).

According to a preferred embodiment of the invention, the number of simultaneous individually modulated light beams should be as high as possible, e.g. more than 100, 500 or 1000 to obtain the desired predictability in relation to properties of the resulting object.

In an embodiment of the invention said at least two simultaneous individually modulated light beams are modulated by means of at least one spatial light modulator.

A spatial light modulator represents an advantageous way of obtaining the required simultaneous individually modulated light beams in a high number.

In an embodiment of the invention said at least two simultaneous individually modulated light beams are modulated by means of at least one spatial light modulator according to illumination control signals (ICS).

Illumination control signals may typically be produced by an illumination control unit (CU) comprising data processing means. Such data processing means may e.g. comprise a raster image processor.

In an embodiment of the invention said at least two simultaneous individually modulated light beams (IMLB) have at least two different wavelength contents.

According to an advantageous embodiment of the invention, the at least two simultaneous individually modulated light beams (IMLB), preferably in a number exceeding 100 or even more, may, at the same time project different wavelength content. This feature may facilitate a rapid flash exposure of the complete object layer or at least a part of it and moreover a uniform and predictable property of the final exposed layer with respect to both or all the, with respect to wavelength content, differently exposed illumination points.

It should be noted that such application of at least two different wavelength contents in a multi-beam application facilitates both a flash exposure or alternatively and a scanning exposure where the illumination with the two or more different wavelength contents may be obtained in one scanning movement. Moreover, flash exposure and scanning exposure may be combined.

In an embodiment of the invention said illuminating is performed in one illumination step.

In an embodiment of the invention said illumination is performed in one illumination step by a scanning relative movement between the modulated light beams and the rapid prototyping medium (RPM).

In an embodiment of the invention said illumination is performed in one illumination step by a flash exposure of the modulated light beams onto the rapid prototyping medium (RPM).

In an embodiment of the invention said at least two simultaneous individually modulated light beams (IMLB) have a first wavelength content (WLC1) in a first illumination step (ILS1) and wherein said at least two simultaneous individually modulated light beams (IMLB) have a further wavelength content (WLC2) in a second illumination step (WLC2).

The invention furthermore offers the possibility of separating the illumination into two or further illumination steps while still maintaining the required predictability of properties both with respect to the property distribution over the individual layers of the final rapid prototyping object and mutually obtained properties of the complete layers.

In an embodiment of the invention said rapid prototyping medium (RPM) is illuminated at different modulation points (MP).

It is noted that an illumination point may be obtained by one or several illumination beams.

In an embodiment of the invention the at least one spatial light modulator comprises LCD (LCD: liquid crystal display), PDLC, (PDLC: Polymer-dispersed liquid crystal), PLZT (PLZT: Lead-doped lanthanum zirconate titanate), FELCD (FELCD: ferroelectric liquid crystal display) or Kerr cells.

In an embodiment of the invention the at least one spatial light modulator comprises reflection based electromechanical light valves, such as DMD (DMD: Digital Micro-mirror Devices) spatial light modulators.

DMD spatial light modulators may e.g. be of the DLP type as made by Texas Instruments.

In an embodiment of the invention the at least one spatial light modulator comprises transmissive electromechanical light valves.

The transmissive based electromechanical light valves may e.g. be made according to the teaching of PCT/DK98/00155, hereby incorporated by reference.

Both the transmissive electromechanical light valves and the above mentioned reflective spatial light modulators are particular advantageous in conjunction with the provisions of the present invention due to the ability of these systems to project large effective amount of energy to the final illumination points at the rapid prototyping medium.

In an embodiment of the invention the at least two simultaneous individually modulated light beams (IMLB) are provided by at least one illumination source (LS).

In an embodiment of the invention the at least two simultaneous individually modulated light beams (IMLB) are provided by at least one illumination source (LS) via a light guide arrangement.

The light guide arrangement may e.g. comprise appropriate injection and/or collimation optics, optical fibres, customized design lenses, etc. The light guide arrangement may e.g. be designed according to the provisions of PCT/DK98/00154, hereby incorporated by reference.

In an embodiment of the invention said illumination with different wavelength content results in different properties of the final object (101) depending on the applied wavelength content.

Different properties may e.g. relate to hardness, elasticity, fragility, etc. Examples of such properties may be physical, optical, electrical, chemical, magnetic or any other relevant properties including any combinations hereof.

In an embodiment of the invention said illumination is established layerwise.

In an embodiment of the invention said layerwise illumination provides an object (101, 102) resulting from curing of said rapid prototyping medium obtained through said illumination.

In an embodiment of the invention one of said different wavelength contents is applied for illumination of an object (101) and where at least one other wavelength content is applied for illumination of at least one support structure (102).

In an embodiment of the invention said support structure (102) is removable or easier removable due to the illumination of said at least one other wavelength content.

In an embodiment of the invention said illumination source (LS) comprises one or several monochromatic lasers, one or several broad band illumination sources such as short arc gap lamps or any combination thereof.

In an embodiment of the invention said illumination source (LS) is a UV light source.

In an embodiment of the invention the time difference between the illumination steps differs less than 500%, preferably less than 100% and most preferably less than about 10%.

In conventional single point rapid prototyping systems, illumination time of the illumination steps may vary significantly. According to an embodiment of the invention such time differences may vary less than 10% or even 1%, thereby obtaining the desired predictability of properties in a convenient and reliable way.

Moreover the invention relates to a rapid prototyping system comprising an illumination unit (IU), at least one illumination source (LS), at least one control unit (CU) wherein said rapid prototyping system facilitates illumination of a rapid prototyping medium (RPM) according to any of embodiments of the present invention.

Moreover the invention relates to the use of wavelength control for the purpose of obtaining differentiated properties of an object illuminated in a multi-beam rapid prototyping illumination system.

Moreover the invention relates to a method of rapid prototyping whereby a prototype (101) is provided by illumination of light sensitive material (100A, 100B, 100C) and where said illumination involves control of wavelength content.

The word prototype is not limited to the production of a unique object but it can also cover a production in a various, large or small, scale or even a single layer. Therefore, rapid prototyping generally refers to rapid manufacturing techniques such as rapid tooling, rapid manufacturing and of course the conventional understanding of rapid prototyping.

The illumination can come from different monochromatic light sources e.g. lasers or from a light source with a broad variety of wavelengths. The light to be used can be either UV, IR or in the visible region. Preferably the wavelengths to be used can be in the area between 300 nm and 800 nm.

With controlling the wavelength content it is to be understood that at the wavelength content may be controlled to comprise light with one, two or several different wavelengths or different content of wavelength components.

With two light sources these can advantageously each have their own wavelength to constitute the necessary wavelengths according to the invention. With a light source having a broad variety of wavelengths the at least two necessary different wavelengths can be chosen by the help of e.g. a grating or through filters to select the two needed wavelengths.

It is moreover noted that control of wavelength content of the light applied for illumination implies not only at least two different wavelengths of light but also e.g. two different spectral profiles allowing even the same content of wavelengths but having different weighting.

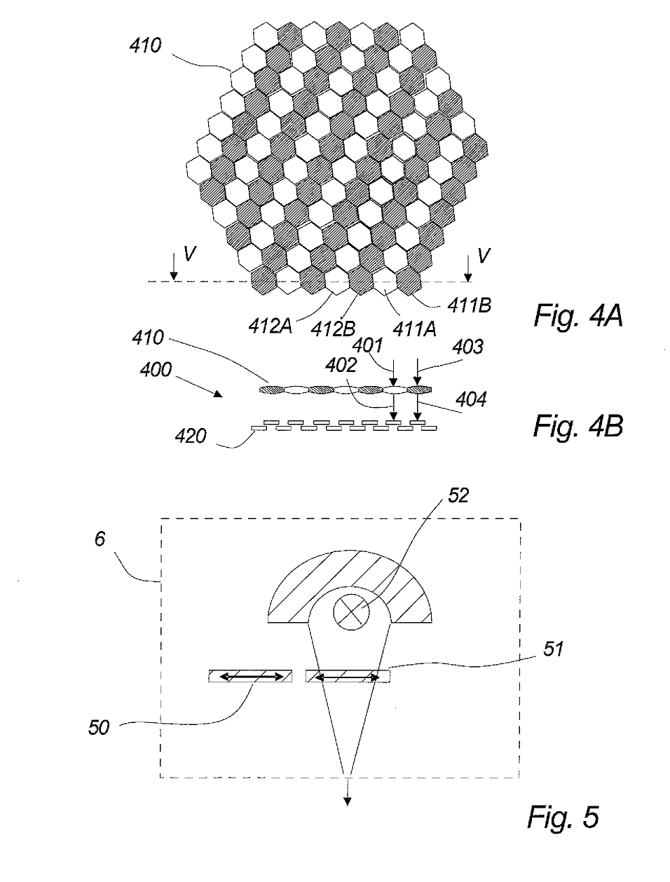

The general principles of an embodiment of a rapid prototyping apparatus is disclosed in EP 1 156 922. Modifications suitable for applying such apparatus according to the provisions of this invention is explained below, e.g. with reference to FIGS. 4a, 4b and FIG. 5.

Further principles regarding the illumination system are disclosed in PCT/DK98/00155 and PCT/DK98/00154. In order to obtain the desired differentiated wavelength content such systems may e.g. be supplemented with filters as explained in FIGS. 4a and 4b or the exposure system may comprise one or several filters which may be exchanged during operation of the apparatus e.g. as shown and explained in connection with FIG. 5.

In an embodiment of the invention a rapid prototyping apparatus for the manufactures three dimensional objects by additive treatment of cross sections comprising a wholly or partially light-sensitive material, said apparatus comprising at least one light source for illumination of a cross section of the light-sensitive material by at least one spatial light modulator of individually controllable light modulators, wherein at least one light source being optically coupled with a plurality of light guides arranged with respect to the spatial light modulator arrangement in such a manner that each light guide illuminates a sub-area of the cross section.

The invention provides the opportunity to design a given RP system for handling prototypes of any size as the number of light emitters and thereby individual areas to be covered may be increased or decreased until it matches the size of the prototype in question. In this manner, it becomes possible and simple to design an illumination system for an RP system constructed as a module system having a number of illumination modules that may be suitably added or arranged in relation to the system design. This flexibility may in principle be utilized for both the design of RPs for large-scale prototypes and of more consumer-oriented RPs for small-scale models.

Also, the multiple light emitters provide the opportunity to use light sources in the shape of dots. By applying a system in accordance with the invention, it is possible to obtain a diameter of the punctual point of illumination of as little as 10 μm in comparison with the existing technique with an absolute low of 80 μm. This is of great advantage when manufacturing prototypes where great precision properties are required. This includes e.g. the manufacturing of tools where the prototype is provided with a metal coat subsequent to the manufacturing prior to being used for the molding of a tool.

Certain areas of this technique apply a prolonged light source such as e.g. a fluorescent lamp or an excimer lamp in order to be able to produce prototypes of a certain dimension. However, according to the optical laws, prolonged light sources alone only provide the opportunity to create a prolonged point of illumination which, in turn, significantly limits the potential of making details in the prototype. Apart from that, prolonged light sources are subject to relatively large losses.

According to the invention, the definition of beam-forming light is broad and includes electromagnetic radiation, both within and outside the visible spectrum.

It is moreover noted that the method preferably may relate to illumination of and manufacturing of an object comprising one or several layers, although several layers are typically preferred.

Alternatively, quite a lot of optics must be used in connection with the prolonged light sources in order to adjust the shape of the point of illumination. Naturally, this makes the system more expensive while also requiring a great degree of accuracy when monitoring the optics.

Application of multiple light emitters may also provide the opportunity to increase the illumination effect over the complete illuminated cross section since each sub-area of the complete cross section can be illuminated by an individual light emitter or even an illuminant. This is an advantage as it becomes possible to tailor the illumination effect to the individual prototype in such a manner that it is created with optimal illumination effect. This technology is generally described in PCT/DK98/00154, hereby incorporated by reference.

A liquid (a floating photopolymer), with the ability that during illumination with electromagnetic radiation, e.g. light with one or several wavelengths (e.g. 436 nm) or one certain wavelength range (e.g. 400-450 nm) hardens (polymerizes) in such a way that it can be dissolved again in a liquid like e.g. water or alcohol, while under radiation with electromagnetic radiation—e.g. light at one or several other wavelengths (e.g. 365 nm) or in another wavelength range (e.g. 350-400 nm (UV-light)) hardens (polymerizes) in such a way that it cannot immediately be dissolved in the one or several liquids which above mentioned can be used to dissolve the hardened photopolymer.

The liquid is applied with the building of sequential cross section layers to make up 3-dimensional objects in a machine for use in connection with rapid prototyping (RP), rapid manufacturing (RM), rapid tooling (RT) and other similar processes.

Examples of this are machines for illuminating photopolymers from the companies 3D Systems Inc., Envisiontec GmbH, Sony and Dicon A/S. A reference can be made to the Rapid Prototyping-patent EP 1 156 922 from Dicon A/S.

The liquid being illuminated could be a cationic initiated photopolymer.

The liquid is placed in a container or a vessel where it is exposed to electromagnetic radiation.

Methods to expose light as described above concerning the dividing of the light in wavelengths or wavelength ranges. Of course the method can be enlarged to divide light in more than two different wavelengths or two wavelength intervals.

One of the purposes of an embodiment of the invention may be to solve the problem of removal of support structures on built 3-dimensional objects in such a way, that they can be removed from the built objects by being dissolved in a liquid and washed away. This opens for a possibility of automation of the process in a way that removal of support structures can happen without the involvement of manual processes.

An alternative purpose within the scope of the invention may be to modify and differentiate other relevant properties by means of the curing.

The exposure of light with different wavelengths can happen in several ways, e.g.:

By the use of several different light sources, each of which illuminates with different wavelengths or wavelength ranges. An example of this is light-emitting diodes.

By the use of one or several light sources which illuminates in a broad range being divided in an appropriate way into different wavelengths or wavelength ranges. An example of this is a mercury discharge lamp (high pressure arc gap lamp).

The division of light into different wavelengths or wavelength ranges could e.g. happen by:

On transmissive light modulating modules of a type being e.g. mentioned in U.S. Pat. No. 6,529,265 with coating of the micro lenses on each module in an appropriate pattern in a way that some lenses are coated to let light pass in one or several specific wavelengths or one or several wavelength ranges, while other lenses are coated in a way to let light in one or several others (complementary) wavelengths or one or several others (complementary) wavelength ranges pass. e.g. every two lenses could be coated with one type of filter and the remaining med another type of filter (see FIG. 4a and FIG. 4b)

By arranging one or several modules on a scanning bar the surface of the liquid in one scanning movement can be illuminated several different wavelengths dependent of whether object material should be hardened or support structures should be built. Obviously it is possible to scan several times and illuminate with different wavelengths for each scan.

By coating all lenses in one or several modules with one type of filter and all lenses in one or several other modules with another type of filter and arrange the modules on one or several scanning bars in such a way that both above mentioned types of modules scan the same area, it is possible by doubling modules (create redundancy) to illuminate the surface of the liquid in one scanning movement with several different wavelengths dependent on if object material is to be hardened or support structures should be built. Obviously it is possible to scan several times on the liquid and illuminate with different wavelengths for each scan. It is also possible within the scope of the invention to coat with more than two filters in order to achieve e.g. three or even further different resulting properties.

It is also possible that the same surface could be illuminated with two or several separate illumination steps where one or several modules in the first illumination step is being illuminated with light in one or several specific wavelengths or one or more wavelength ranges while the same module or modules in another illumination step is illuminated with one or several other (complementary) wavelengths or one or more other (complementary) wavelength ranges. The exposure of light with different wavelengths or wavelength intervals can happen e.g. by insertion of different filters somewhere between light source and liquid e.g. between light source and module or modules (see FIG. 5), or by the use of different light sources with different wavelengths for each illumination step.

Also in this case the modules can be arranged on a scanning bar like above mentioned.

By coating and illuminating as above mentioned, and at the same time arrange one or several modules in such a way, that the liquid surface can be illuminated without a scanning movement, exposure by flash is made possible on a liquid surface with several different wavelengths or wavelength ranges all at once.

By arranging one or several modules in such a way that the liquid surface can be illuminated without a scanning movement and at the same time illuminate the surface with two or several separate exposures as above mentioned by insertion of different filters somewhere between light source and liquid or by using different light sources with different wavelengths for each illumination, exposure by flash is also made possible on a liquid surface with several different wavelengths or wavelength ranges.

By, on a reflective light modulation module of a kind like e.g. DMD chip from TI, coating a matrix consisting of different mirrors with different coatings that reflects different wavelengths or different wavelength ranges. e.g. every two mirrors could be coated with one type of filter that reflects one wavelength or one wavelength range, and the remaining mirrors (the other “every two”) could be coated with another type of filter that reflects another wavelength or another wavelength range. The mirrors are placed in such a way that they illuminate the surface on the photo polymer when they are tilted in one direction and do not illuminate the surface when they are tilted in the other direction.

When the mirrors are tilted in one direction the surface on the liquid is thereby being illuminated with one or the other wavelength or wavelength range—dependent on whether the object material or the support structure material is being polymerized. The position of the mirrors is controlled by the bitmap-information that forms the pictures in the layer parts of the additive process.

A principle like this makes exposure by flash possible on a liquid surface with several different wavelengths or wavelength ranges all at once without a scanning movement making part thereof.

It is possible as well to imagine that the same liquid surface is illuminated with two or several separate illumination steps, where the mirrors in one illumination step is being illuminated with light with one wavelength or one wavelength range and in the other illumination step or illumination steps is being illuminated with light with another wavelength/wavelengths or another wavelength range/ranges. The exposure of light with different wavelengths or wavelength ranges can e.g. be at insertion of different filters somewhere between light source and liquid or by the use of different light sources with different wavelengths for each illumination.

A principle like this makes exposure by flash possible on a liquid surface with several different wavelengths or wavelength ranges all at once without a scanning movement making part thereof.

The two possibilities mentioned in the two paragraphs just above starting with “By, on a reflective . . .” and “It is possible as well . . .” can also be combined with a scanning movement of the light modulation module in such a way that it is not only in connection with exposure by flash that this principle can be used but also in connection with scanning across larger surfaces.

### FIGURES

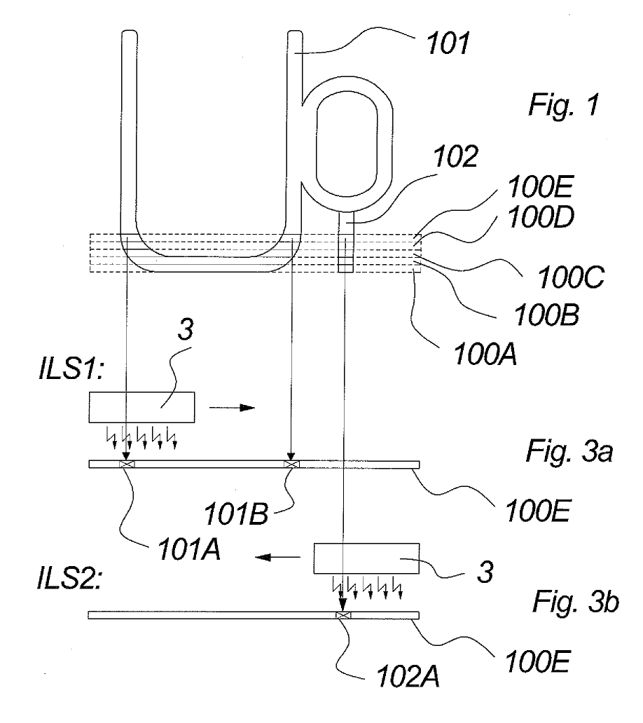

The invention will be described in detail in the following with reference to the figures where FIGS. 1-6 show different embodiments of the invention.

### DETAILED DESCRIPTION

FIG. 1 shows the RP principle of building up an object 101 by sequential cross section layers; here a cup is being built.

The different layers 100A, 100B, 100C, and so forth are illuminated one at a time bottom up. The areas which are illuminated are hardened and the areas that are not illuminated maintain liquid in which way we end up with a final structure.

A support structure 102 in FIG. 1 is introduced to stabilize the structure. Advantageously this support structure should be easy removable after the final product is created.

It is an object of the present invention to establish a method to make support structures less or differently hardened and thereby easier removable after production. For this purpose a single wavelength or a well established narrow or broad range of wavelengths can be used to illuminate the light sensitive medium 2.

One way of obtaining a different hardening may e.g. be obtained if the hardened light sensitive medium has different mechanical properties if illuminated with different wavelength content, thereby e.g. leaving support structures weak and easily removable and the remaining part of the prototype solid.

Another way of obtaining different hardening may e.g. be obtained if the hardened light sensitive medium has different chemical or physical properties if illuminated with different wavelength content, thereby leaving e.g. the support structures illuminated by one wavelength content removable by e.g. a solvent like water or alcohol and where remaining part of the prototype is resistant to such solvent.

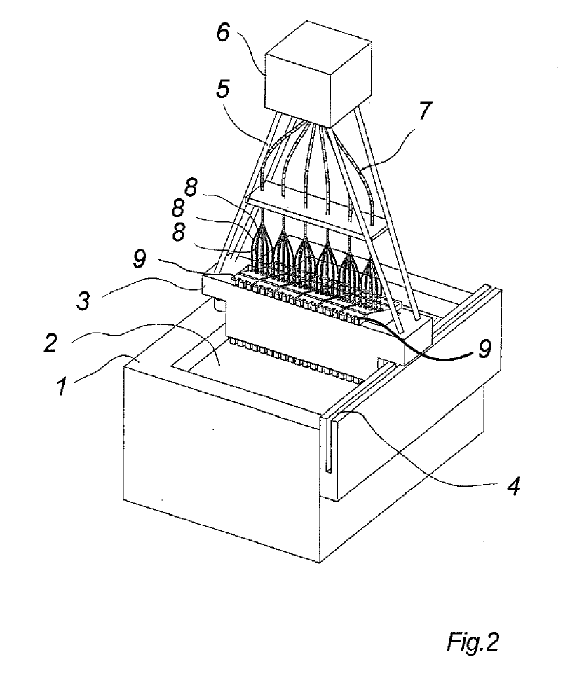

EP 1 156 922, hereby incorporated by reference, contains a Rapid Prototyping Apparatus as shown in FIG. 2.

The shown Rapid Prototyping (RP) apparatus comprises a stationary part whose most significant component consists of a container 1 designed to contain a suitable amount of liquid RP material 2.

An RP material is the material of which the RP prototype will be made such as epoxy, acrylates or other RP materials or any material which may harden differently when exposed with different wavelength content. In addition, the stationary part is designed with a leader 4 which can be positioned for various purposes between the stationary part and a movable illumination device 3. The illumination device may also comprise corresponding leader (not shown) for e.g. a vertical movement. The RP apparatus also comprises other computer-controlled means (not shown) designed to control a relative movement of the illumination device 3 corresponding to a suitable computer-aided design of the illumination system of the RP apparatus.

The illumination device 3 is also provided with an illumination system whose most important components will be described in the following.

The illumination device 3 comprises a light source arrangement 6 mounted on a rack 5 comprising known necessary means of illumination together with a power supply and cooling means. The light source is illustrated as a UV source in the shown example. The light source with its aggregates and cooling means may be stationary or movable.

The light source arrangement 6 is optically connected with bundles 7 of optical multi mode fibers. These bundles 7 spread into eight individual fibers 8 where each fiber illuminates a microshutter arrangement of e.g. 588 micromechanical light valves. Thus, in unison, the eight individual fibers illuminate an illumination device 9 comprising eight microshutter arrangements, each constituting an individual area of the entire microshutter arrangement.

The construction itself and the orientation of these light valves have been described in the international application Nos. PCT/DK98/00154 and PCT/DK98/00155 also by the inventor of this invention and are hereby incorporated by reference.

Each individual area comprises a number of light valves that may be individually controlled electrically by a connected control circuitry (not shown). The light valve arrangement may e.g. be an LCD display with a given desired solution. However, micromechanical shutters are preferable.

The entire area of light valves is illuminated by one single light guide 8 arranged in such a manner that a light beam emitted from the light guide 8 may furnish all light valves occupying an individual area with optical energy.

It should be noted that the light beam will usually be furnished through the collimating optics to the sub-areas in such a manner that the light beam with which the spatial light modulator has been furnished is uniform in respect of energy over the modulator area.

The microshutters in the illumination modules 9 have been designed to conduct a scanning over a scanning line of 25 to 30 centimeters in the shown illumination arrangement.

It is obvious from the example that the length of the scanning line to be used, i.e. one of the maximum dimensions of a manufactured RP prototype, may be shaped as desired in contrast to existing techniques since the “local” illumination of the individual illumination modules may be oriented in any direction on the illumination surface. This may e.g. be done by varying of an applied exposure bar used for illumination of a light sensitive medium. Apart from that, it is also immediately obvious that the method of illumination by means of one central light source and the coupled optical guides provides a tremendous advantage in respect of design which is naturally reflected financially and in the quality of the completed construction. The shown construction is thus extremely robust and any defects or damaged light modulators may easily be replaced.

In addition, the apparatus is provided with a control circuitry (not shown) designed to provide a relative Z positioning (vertical movement) and orientation between the illumination system and a material 2.

When using wavelengths within a certain range according to prior art standard hardening is established.

FIGS. 3a and 3b illustrate a further embodiment of the invention where the illumination of a layer 100E of the object 101 as shown in FIG. 1 is explained.

The light sensitive material may e.g. comprise epoxy, acrylate or any mixture thereof.

An illumination device 3 e.g. as described above in relation to the already described device of FIG. 2 illuminates the part of a layer 100E intended to form part of the final desired prototype with one wavelength content in one direction as illustrated in FIG. 3a, e.g. 436 nm.

The part of a layer 100E intended to form part of the support structure 102 is illuminated with another wavelength content in the return direction as illustrated in FIG. 3b. The Wavelength content may e.g. 350 nm-400 nm.

FIGS. 4a and 4b illustrate a further embodiment of the invention applicable within the scope of the invention.

The illustrations in FIG. 4a and FIG. 4b illustrate a spatial light modulator (SLM) in the form of a micromechanical shutter—a MEMS device 400. The illustrated SLM may e.g. be illuminated by one of the light guides 8 of FIG. 2. The illustrated device of FIG. 2 may thus e.g. comprise 6×8=48 SLM's of the above-illustrated type.

The illustrated SLM may facilitate the differentiated illumination in one single scanning movement of each layer instead of the above explained two.

The principle illustration of the MEMS SLM 400 comprises a base plate 420 supplied with light channels and a number of electrically actuable shutters. Each shutter is fed by a micro lens arranged in a micro lens array 410 of micro lenses 411A, 411B, 412A, 412B, etc. A number of the micro lenses 411B, 412 B etc. are provided with optical filters.

As illustrated in FIG. 4b, a light beam 401 will pass the lens 411A “unaffected” (i.e. with usual optical losses) and form a beam 402 whereas the neighboring micro lens 411B will invoke that a light beam 403 will be filtered to form a spectrally modified light beam 404.

Evidently, software control of the switching of the individual shutters may facilitate that, e.g. in a progressive scan, prototype “pixels” are illuminated by e.g. 411A, 412A, etc and support structure “pixels” are illuminated by e.g. 411B, 412B, etc.

Evidently, two or more optical filters may be applied in the above mentioned example in order to obtain three or more different resulting properties.

FIG. 5 illustrates a further alternative embodiment of the invention applied in the apparatus of FIG. 2 where the above explained modified (with filters) SLM are exchanged with usual SLM's such as DMD, LCD or other commercially available devices.

In this embodiment, the light source arrangement 6 has been modified to include two different filters 50 and 51 arrangement with respect to a light source 52, thereby providing an optically output of the light source arrangement where the wavelength content depends on the applied filter 50, 51.

Evidently, three or more optical filters of the above type may be applied in the above mentioned example in order to obtain more than two different resulting properties.

Thus, e.g. one filter 50 may be applied when scanning in the direction of FIG. 3a and another when scanning in the other direction of FIG. 3b.

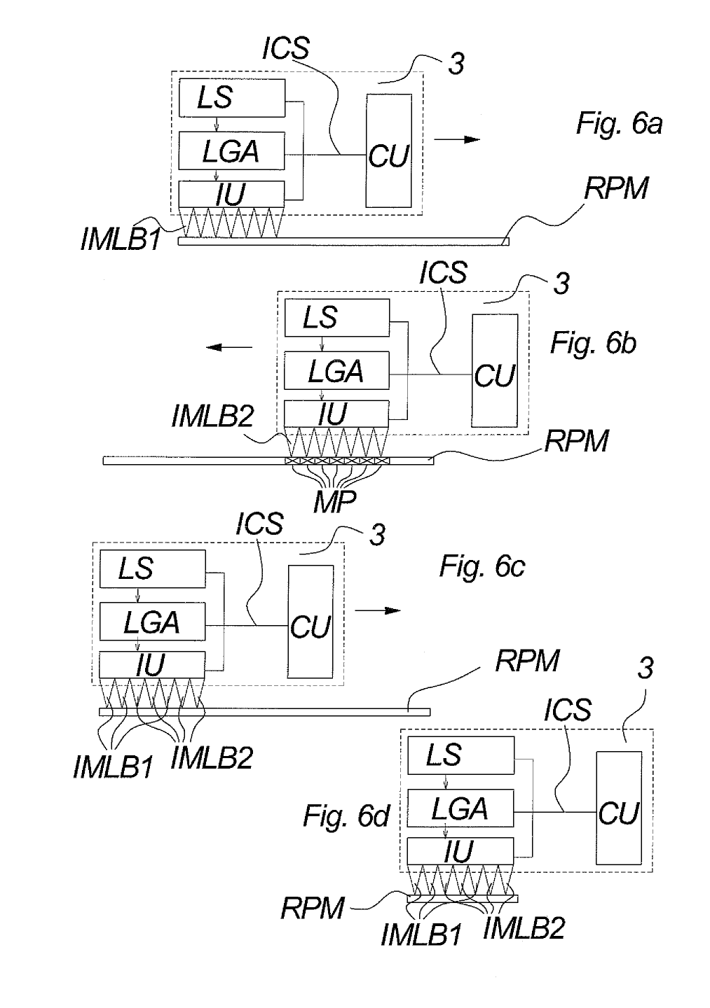

FIGS. 6a and 6b illustrate one of several principles within the scope of the invention, when the illumination is e.g. performed in a system as illustrated in FIG. 1 and FIG. 3a-3b.

Basically, the system comprises an illumination source (LS), preferably a UV light source e.g. in the form of short arc gap lamp. The light source establishes a number of individually controlled light beams having a first wavelength content IMLB1 via a light guide arrangement LGA and an illumination unit IU. The illumination unit IU may e.g. comprise one or several spatial light modulators such as DMD or transmissive micromechanical light modulators.

The illumination unit IU is controlled by a control unit CU establishing the necessary control data.

In FIG. 6a, a layer of a rapid prototyping medium RPM is illuminated in a first illumination step in one direction with modulated light beams IMLB1 having a first wavelength content. The illuminated points of the medium obtain the desired mechanical or chemical properties during the curing.

In FIG. 6b, the same layer is exposed in a further illumination step, now with illumination points MP of the medium exposed by modulated light beams IMLB2 having another wavelength content corresponding to desired mechanical or chemical properties.

It is noted that the use of multiple modulated illumination beams results in a very short time and typically equal time delay between each illumination step, thereby obtaining the desired predictability with respect to properties of the final obtained object.

FIG. 6c illustrates an alternative embodiment of the invention, where a complete layer is exposed with two, or optionally further different wavelength contents IMLB1 and IMLB2, in one illumination step, through a seaming e.g. by a system 3 corresponding to the one illustrated in FIG. 2.

Such scanning may be facilitated by the fact that the system is able to illuminate with two different wavelength contents at the same time.

FIG. 6d illustrates a further alternative embodiment of the invention where the complete layer of the rapid prototyping medium is flash exposed with two, or optionally further different wavelength contents IMLB1 and IMLB2 as one digitally modulated flash exposure of the complete cross-section.

Moreover, the above illustrated techniques may involve use of several illumination units in one illumination head or a scanning bar e.g. as illustrated in FIG. 2 or e.g. as two or more separately moving exposure heads.

1. Method of illuminating at least one rapid prototyping medium comprising illuminating the rapid prototyping medium using at least two simultaneous individually modulated light beams projected onto the rapid prototyping medium and wherein the light beams have at least two different wavelength contents.

2. Method according to claim 1, wherein the illuminating is performed by at least five simultaneous individually modulated light beams projected onto the rapid prototyping medium.

3. Method according to claim 1, wherein the at least two simultaneous individually modulated light beams are modulated by means of at least one spatial light modulator.

4. Method according to claim 3, wherein the at least two simultaneous individually modulated light beams are modulated by means of at least one spatial light modulator according to illumination control signals.

5. Method according to claim 1, wherein the at least two simultaneous individually modulated light beams at the same time project different wavelength content onto the rapid prototyping medium.

6. Method according to claim 1, wherein the illuminating is performed in one illumination step.

7. Method according to claim 1, wherein the illumination is performed in one illumination step by a scanning relative movement between the modulated light beams and the rapid prototyping medium.

8. Method according to claim 1, wherein the illumination is performed in one illumination step by a flash exposure of the modulated light beams onto the rapid prototyping medium.

9. Method according to claim 1, wherein the at least two simultaneous individually modulated light beams have a first wavelength content in a first illumination step and wherein the at least two simultaneous individually modulated light beams have a second wavelength content in a second illumination step.

10. Method according to claim 1, wherein the rapid prototyping medium is illuminated at different modulation points.

11. Method according to claim 3, wherein the at least one spatial light modulator comprises LCD, PDLC, PLZT, FELCD or Kerr cells.

12. Method according to claim 3, wherein the at least one spatial light modulator comprises reflection based electromechanical light valves.

13. Method according to claim 3, wherein the at least one spatial light modulator comprises transmissive electromechanical light valves.

14. Method according to claim 3, wherein the at least two simultaneous individually modulated light beams are provided by at least one illumination source.

15. Method according to claim 1, wherein the at least two simultaneous individually modulated light beams are provided by at least one illumination source via a light guide arrangement.

16. Method according to claim 9, wherein the illumination with different wavelength content results in different properties of a final object depending on the applied wavelength content.

17. Method according to claim 1, wherein the illumination is established layerwise.

18. Method according to claim 16, wherein one of the different wavelength contents is applied for illumination of an object and where at least one other wavelength content is applied for illumination of at least one support structure.

19. Method according to claim 19, wherein the support structure is removable.

20. Method according to claim 15, wherein the illumination source comprises at least one monochromatic laser and at least one broad band illumination source.

21. Method according to claim 21, wherein the illumination source is a UV light source.

22. Method according to claim 9, wherein the time difference between the illumination steps differs less than 10%.

23. An object produced according to a method comprising illuminating a rapid prototyping medium layerwise using at least two simultaneous individually modulated light beams projected onto at least one layer of the rapid prototyping medium and wherein the light beams have at least two different wavelength contents; and curing the rapid prototyping medium.
